(19) United States
(12) Patent Application Publication
(10) Pub. No.: US 2010/0162775 A1
(43) Pub. Date: Jul. 1, 2010

(54) Disposable Double Loop Handcuffs with Pivot, Handles and Deployment System

(76) Inventor: Michael Anthony Martinez, Albuquerque, NM (US)

Correspondence Address: YORGOS D. MARINAKIS, 1600 BLACKHAWK RIVER DR. NE, RIO RANCHO, NM, 87144-6416, US

(21) Appl. No.: 12/345,447

(22) Filed: Dec. 29, 2008

(51) Int. Cl. E05B 75/00; B21D 39/00

(52) U.S. Cl. 70/16; 29/428

(57) ABSTRACT

Disposable double loop handcuffs formed from two flexible straps each strap having a first end and a second end, each strap having a terminal hinge member at the first end and a handle at the second end, the first end having an opening that is less distally-positioned and more medially-positioned than the terminal hinge member, the second end inserted through the opening in the first end to form the strap into a loop. The opening contains a unidirectional locking head comprising a ratchet with teeth and pawl, the pawl extending monolithically from the strap on the distal side of the opening, the teeth located on the second end of the strap medial to the handle. The tip of the first end of the first strap has two hinge knuckles for receiving a third hinge knuckle between them. The tip of the first end of the second strap has at least a third hinge knuckle for inserting between the two hinge knuckles of the first strap. In a preferred embodiment, the second strap is identical to the first strap, also having two hinge knuckles, one of which is inserted between the two hinge knuckles of the first strap. The two flexible straps thusly looped are pivotably connected to one another with a rivet through a rivet hole in the hinge knuckles of the terminal hinge members, both handles pointing in the same direction. A method for manufacturing disposable double loop handcuffs formed from two flexible straps.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The embodiments of the present invention satisfy the needs of providing disposable double loop handcuffs.

Information relevant to attempts to address these problems can be found in U.S. Pat. No. 5,797,404; which is not admitted to be prior art with respect to the present invention by its mention in this Background Section. However, it is desirable to have a better device than is disclosed in the reference.

### SUMMARY

The embodiments of the present invention are directed to an apparatus that satisfies the needs set out in the Background section.

The embodiments of the present invention comprise disposable double loop handcuffs formed from two flexible straps each strap having a first end and a second end, each strap having a terminal hinge member at the first end and a handle at the second end, the first end having an opening that is less distally-positioned and more medially-positioned than the terminal hinge member, the second end inserted through the opening in the first end to form the strap into a loop. The opening contains a unidirectional locking head comprising a ratchet with teeth and pawl, the pawl extending monolithically from the strap on the distal side of the opening, the teeth located on the second end of the strap medial to the handle. The tip of the first end of the first strap has two hinge knuckles for receiving a third hinge knuckle between them. The tip of the first end of the second strap has at least a third hinge knuckle for inserting between the two hinge knuckles of the first strap. In the preferred embodiment, the second strap is identical to the first strap, also having two hinge knuckles, one of which is inserted between the two hinge knuckles of the first strap. The two flexible straps thusly looped are pivotably connected to one another with a rivet through a rivet hole in the hinge knuckles of the terminal hinge members, both handles pointing in the same direction.

In a preferred embodiment, the handles further comprise additional members generally perpendicular to the broadest plane of the straps, which additional members form a t-shape with the straps and which facilitate grasping the handle, and which additional members may have inserted in them a reinforcing cylinder. At the intersection with the t-shaped member, the strap may be thickened. That part of the t-shaped member which is on the side of the strap away from the rivet may be longer than that part of the t-shaped member which is on the side of the rivet.

In a preferred embodiment, the terminal ends with the hinge knuckles are substantially thicker than the rest of the strap.

The advantages of the embodiments of the invention include but are not limited to the pivoting function, which makes the stored profile of the cuffs smatter, allowing for storage in a smatter pocket or pouch and for rapid deployment of an initially smatter, less cumbersome device; the independent pull handles and the storage pocket, which both separately and in combination allow for rapid deployment; and the combination of the pivoting function, the independent pull handles and the storage pocket, which in combination allow for rapid deployment.

### DRAWINGS

These and other features, aspects and advantages of the embodiments of the device and/or methods will become better understood with reference to the following description, appended claim and accompanying drawings where:

FIG. 1 shows a perspective view of an embodiment of the present invention in the deployed configuration;

FIG. 2 shows a perspective view of an embodiment of the present invention in the configuration ready for stowing in the pouch;

FIG. 3 shows an exploded view of an embodiment of the present invention in the deployed configuration;

FIG. 4 shows a front elevational view of an embodiment of the present invention in the deployed configuration, the rear being a mirror image thereof;

FIG. 5 shows a side plan view thereof, the other side being a mirror image thereof;

FIG. 6 shows a bottom plan view thereof of an embodiment of the present invention having four hinge knuckles, two on each strap;

FIG. 7A shows a partial sectional view of an embodiment of the present invention in the deployed configuration;

FIG. 7B shows a sectional view of the ratchet;

FIG. 8A shows a perspective view of a flexible strap; and

FIG. 8b shows a perspective view of a handle.

### REFERENCE NUMERALS FOR DRAWINGS

10 flexible strap;
11 first end;
12 second end;
13 tip;
15 terminal hinge member;
20 opening;
25 handle;
26 reinforcing cylinder;
30 hinge knuckle;
35 unidirectional locking head;
36 ratchet;
37 pawl;
38 teeth;
40 rivet hole;
41 rivet;
45 t-shaped members;
50 deployment pocket or pouch; and
55 handcuffs.

### DESCRIPTION

### Definitions

Plastic means polymer, high density polyethylene, nylon, PVC, or a polymer composite such as one containing graphite or aramid fibers.

### DESCRIPTION OF THE PREFERRED EMBODIMENT

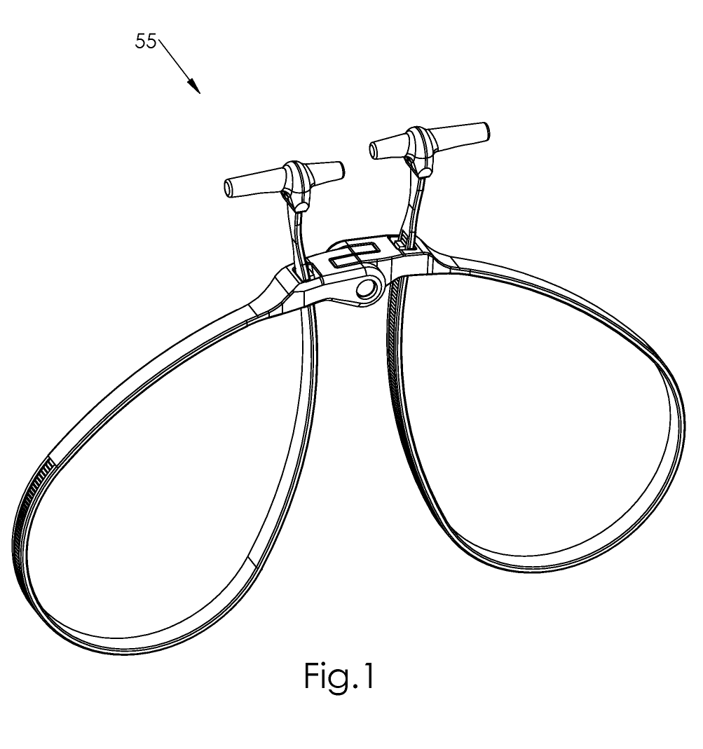

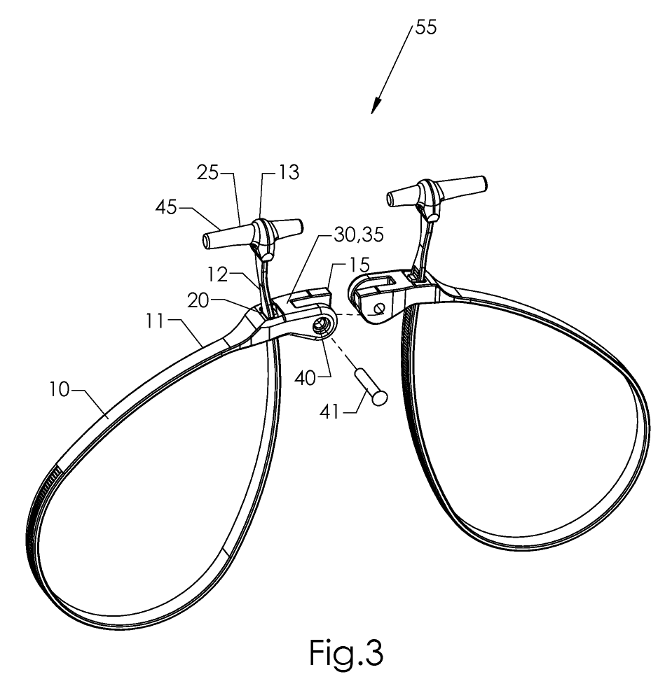

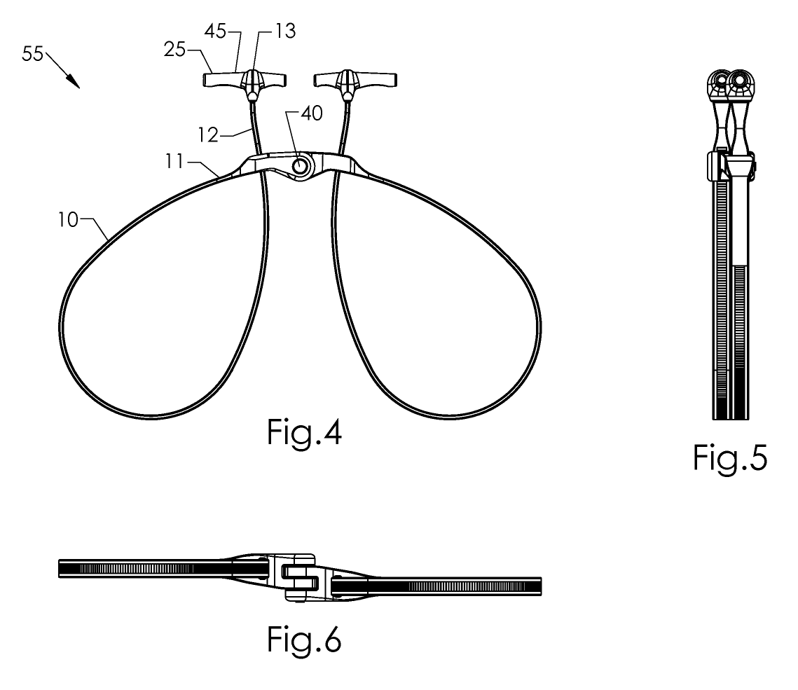

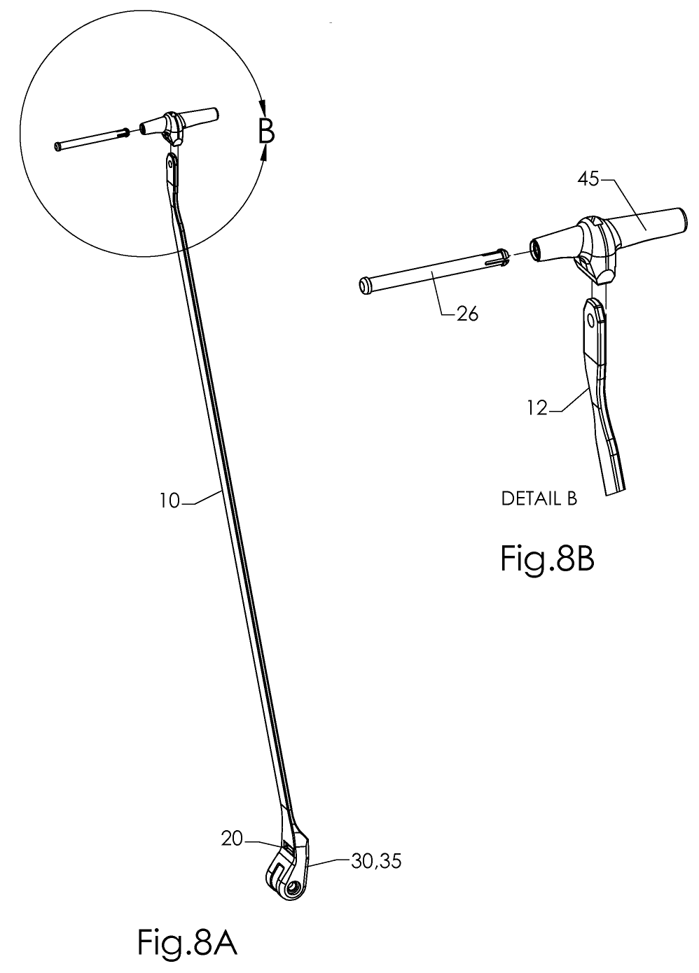

Referring now to the drawings FIGS. 1 through 8, the embodiments of the present invention consist of disposable double loop handcuffs 55 formed from two flexible straps 10 each strap 10 having a first end 11 and a second end 12, each strap 10 having a terminal hinge member 15 at the first end 11 and a handle 25 at the second end 12, the first end 11 having an opening 20 that is less distally-positioned and more medially-positioned than the terminal hinge member 15, the second end 12 inserted through the opening 20 in the first end 11 to form the strap 10 into a loop. The opening 20 contains a unidirectional locking head 35 comprising a ratchet 36 and pawl 37, the pawl 37 extending monolithically from the strap 10 on the distal side of the opening 20, the teeth 38 located on the second end 12 of the strap 10 medial to the handle 25. The tip 13 of the first end 11 of the first strap 10 has two hinge knuckles 30 for receiving a third hinge knuckle 30 between them. The tip 13 of the first end 11 of the second strap 10 has at least a third hinge knuckle 30 for inserting between the two hinge knuckles 30 of the first strap 10. In an alternate, preferred embodiment, the second strap 10 is identical to the first strap 10, also having two hinge knuckles 30, one of which is inserted between the two hinge knuckles 30 of the first strap 10. The two flexible straps 10 thusly looped are connected to one another with a rivet 41 through a rivet hole 40 in the hinge knuckles 30 of the terminal hinge members 15, both handles 25 pointing in the same direction. The embodiments of the present invention, therefore, are particularly but not exclusively useful for the rapid tactical deployment of a device that restrains the wrists.

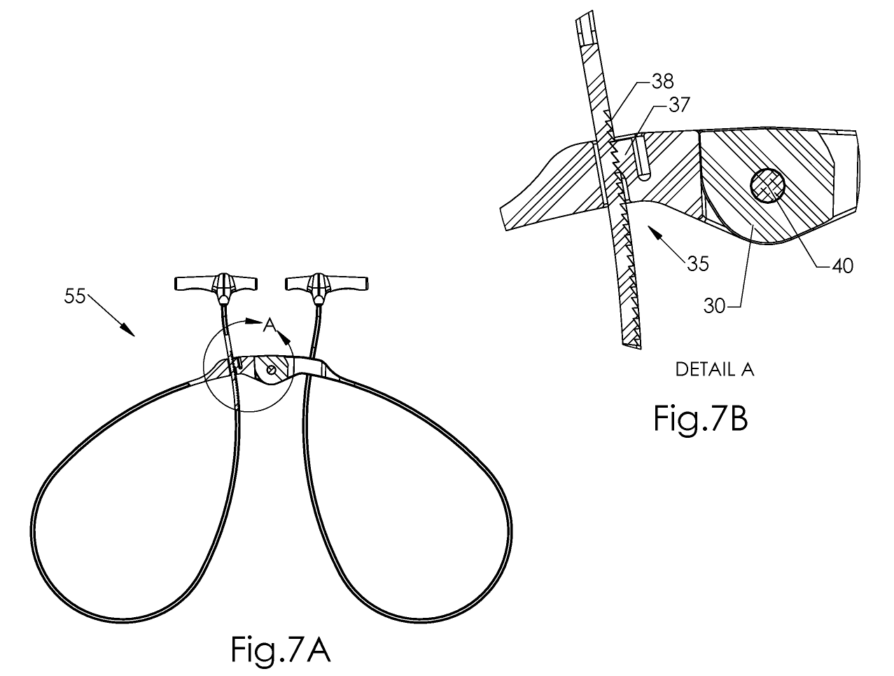

As shown in FIG. 7B, the flexible strap 10 must fit snugly in the hole 20; otherwise the pawl 37 could be forced to disengage from the teeth 38 and the strap 10 could be loosened. As shown in FIG. 7B, in the deployed position the terminal hinge member 15, that is, the distal end of the hinge knuckle 30, meets flush with the opposing hinge knuckle 30, preventing the cuffs 55 from pivoting further.

In the embodiments of the present invention the second end 12 of each strap 10 is inserted through the unidirectional locking head 35 in the opening 20 in the terminal hinge member 15 in its first end 11, to form a loop. The two flexible straps 10 thusly looped are connected to one another with a rivet 41 through a rivet hole 40 in the hinge knuckles 30 of the terminal hinge members 15, with both handles 25 pointing in the same direction.

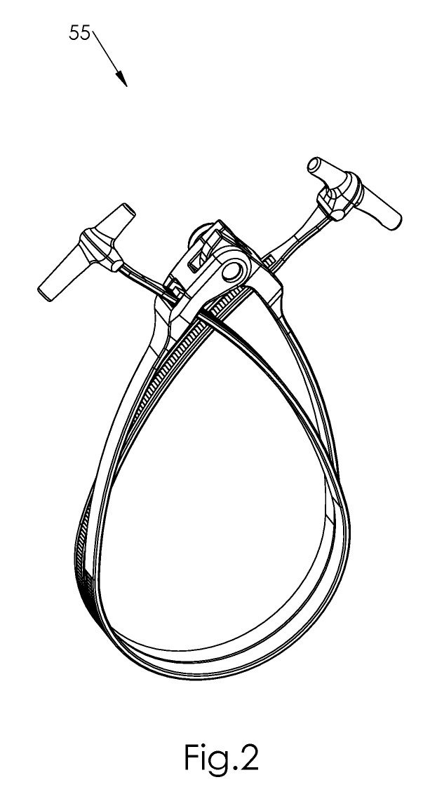

The two loops can be rotated into a position where they overlap to some extent. The position in which the two loops fully overlap, as shown in FIG. 2, is the position in which the invention is stowed in the deployment pouch or pocket 50.

In a preferred embodiment, the handles 25 have additional members 45 generally perpendicular to the broadest plane of the straps 10, which additional members 45 comprise a t-shaped member 45 with the straps 10 and which facilitate grasping the handle 25, and which additional members 45 may have inserted in them a reinforcing cylinder 26.

At the intersection with the t-shaped member 45, the strap 10 may be thickened. That part of the t-shaped member 45 which is on the side of the strap 10 away from the rivet 41 may be longer than that part of the t-shaped member 45 which is on the side of the rivet 41.

In a preferred embodiment, the first ends 11 are substantially thicker than the rest of the strap 10.

The invention also includes a method for manufacturing disposable double loop handcuffs, comprising: providing two flexible straps, each strap having a first end and a second end; providing each strap with a terminal hinge member at the first end and a handle at the second end, the first end having an opening that is less distally-positioned and more medially-positioned than the terminal hinge member, the second end inserted through the opening in the first end to form the strap into a loop; providing the opening with a unidirectional locking head comprising a ratchet with teeth and pawl, the pawl extending monolithically from the strap on the distal side of the opening, the teeth located on the second end of the strap medial to the handle; providing the tip of the first end of the first strap with two hinge knuckles for receiving a third hinge knuckle between them; providing the tip of the first end of the second strap with at least a third hinge knuckle for inserting between the two hinge knuckles of the first strap, the tip of the first end of the first strap having two hinge knuckles for receiving a third hinge knuckle between them, the tip of the first end of the second strap having at least a third hinge knuckle for inserting between the two hinge knuckles of the first strap, through which hinge knuckles the two straps are connected.

The providing-two-flexible-straps step may further include providing a second strap that is identical to the first strap, also having two hinge knuckles, one of which is inserted between the two hinge knuckles of the first strap, the two flexible straps thusly looped being pivotably connected to one another with a rivet through a rivet hole in the hinge knuckles of the terminal hinge members, arranged with both handles pointing in the same direction.

The providing-each-strap-with-a-handle step may further include additional members generally perpendicular to the broadest plane of the straps, which additional members form a t-shape with the straps and which facilitate grasping the handle, and which additional members may have inserted in them a reinforcing cylinder.

The method may further include the step of thickening the strap at the intersection with the t-shaped member.

The method may further include the step of making longer that part of the t-shaped member which is on the side of the strap away from the rivet, than that part of the t-shaped member which is on the side of the rivet.

The method may further include the step of making the terminal ends with the hinge knuckles substantially thicker than the rest of the strap.

In a preferred embodiment, the flexible straps 10 are manufactured preferably with a plastic, such as high density polyethylene, nylon, PVC, or a polymer composite containing graphite or aramid fibers. In a preferred embodiment, the rivet 41 is made of steel.

### Some Advantages of the Embodiments of the Invention

As previously mentioned, the advantages of the embodiments of the invention include but are not limited to the pivoting function, which makes the size of the cuffs 55 smatter, allowing for storage in a smaller pocket or pouch 50 and for rapid deployment of an initially smaller, less cumbersome device; the handles 25 and the storage pocket 50, which both separately and in combination allow for rapid deployment; and the combination of the pivoting function, the handles 25 and the deployment pocket or pouch 50, which in combination allow for rapid deployment of the handcuffs 55.

### Method for Using the Embodiments of the Invention

As shown in FIG. 2, to store the handcuffs 55, the two loops are pivoted towards one another until the loops generally overlap. The handcuffs 55 are then pushed into the deployment pocket or pouch 50, loops first so that the handles 25 extend outward from the pocket or pouch 50. To deploy the preferred embodiment of the handcuffs 55, extend your index and fourth fingers extended and your second and third fingers, wrap your index and fourth fingers around one each of the t-shaped members 45 on the handles 25, and pull the handcuffs 55 out of the deployment pocket or pouch 50.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, the rivet could be made of a polymer, or the device could be used to restrain the ankles. Therefore, the spirit and scope of the appended claims should not be limited to the description of the versions contained therein.

I claim:

1. Disposable double loop handcuffs formed from two flexible straps, each strap having a first end and a second end, each strap having a terminal hinge member at the first end and a handle at the second end, the first end having an opening that is less distally-positioned and more medially-positioned than the terminal hinge member, the second end inserted through the opening in the first end to form the strap into a loop, the opening containing a unidirectional locking head comprising a ratchet with teeth and pawl, the pawl extending monolithically from the strap on the distal side of the opening, the teeth located on the second end of the strap medial to the handle, the tip of the first end of the first strap having two hinge knuckles for receiving a third hinge knuckle between them, and the tip of the first end of the second strap having at least a third hinge knuckle for inserting between the two hinge knuckles of the first strap, the tip of the first end of the first strap having two hinge knuckles for receiving a third hinge knuckle between them, the tip of the first end of the second strap having at least a third hinge knuckle for inserting between the two hinge knuckles of the first strap, through which hinge knuckles the two straps are connected.

2. The device of claim 1, wherein the second strap is identical to the first strap, also having two hinge knuckles, one of which is inserted between the two hinge knuckles of the first strap, the two flexible straps thusly looped being pivotably connected to one another with a rivet through a rivet hole in the hinge knuckles of the terminal hinge members, arranged with both handles pointing in the same direction.

3. The device of claim 1, wherein the handles further comprise additional members generally perpendicular to the broadest plane of the straps, which additional members form a t-shape with the straps and which facilitate grasping the handle, and which additional members may have inserted in them a reinforcing cylinder.

4. The device of claim 3, where the strap is thickened at the intersection with the t-shaped member.

5. The device of claim 3, where that part of the t-shaped member which is on the side of the strap away from the rivet is longer than that part of the t-shaped member which is on the side of the rivet.

6. The device of claim 1, wherein the terminal ends with the hinge knuckles are substantially thicker than the rest of the strap.

7. A method for manufacturing disposable double loop handcuffs, comprising:
providing two flexible straps, each strap having a first end and a second end;
providing each strap with a terminal hinge member at the first end and a handle at the second end, the first end having an opening that is less distally-positioned and more medially-positioned than the terminal hinge member, the second end inserted through the opening in the first end to form the strap into a loop;
providing the opening with a unidirectional locking head comprising a ratchet with teeth and pawl, the pawl extending monolithically from the strap on the distal side of the opening, the teeth located on the second end of the strap medial to the handle;
providing the tip of the first end of the first strap with two hinge knuckles for receiving a third hinge knuckle between them;
providing the tip of the first end of the second strap with at least a third hinge knuckle for inserting between the two hinge knuckles of the first strap, the tip of the first end of the first strap having two hinge knuckles for receiving a third hinge knuckle between them, the tip of the first end of the second strap having at least a third hinge knuckle for inserting between the two hinge knuckles of the first strap, through which hinge knuckles the two straps are connected.

8. The method of claim 7, wherein the providing-two-flexible-straps step further includes providing a second strap that is identical to the first strap, also having two hinge knuckles, one of which is inserted between the two hinge knuckles of the first strap, the two flexible straps thusly looped being pivotably connected to one another with a rivet through a rivet hole in the hinge knuckles of the terminal hinge members, arranged with both handles pointing in the same direction.

9. The method of claim 7, where in the providing-each-strap-with-a-handle step further includes additional members generally perpendicular to the broadest plane of the straps, which additional members form a t-shape with the straps and which facilitate grasping the handle, and which additional members may have inserted in them a reinforcing cylinder.

10. The method of claim 7, further including the step of thickening the strap at the intersection with the t-shaped member.

11. The method of claim 7, further including the step of making longer that part of the t-shaped member which is on the side of the strap away from the rivet, than that part of the t-shaped member which is on the side of the rivet.

12. The method of claim 7, further including the step of making the terminal ends with the hinge knuckles substantially thicker than the rest of the strap.
